(19) United States
(12) Patent Application Publication
(10) Pub. No.: US 2018/0209403 A1
(43) Pub. Date: Jul. 26, 2018

(54) Wind powered generator with adaptable blade angles

(71) Applicant: Guixian Lu, Holly, MI (US)

(72) Inventor: Guixian Lu, Holly, MI (US)

(21) Appl. No.: 15/414,707

(22) Filed: Jan. 25, 2017

(51) Int. Cl. F03D 7/06; F03D 3/00; F03D 80/70; F03D 3/06

(52) U.S. Cl. CPC F03D 7/06; F03D 3/064; F03D 80/70; F03D 3/005

(57) ABSTRACT

All blades on one side of rotor have good blade angles for gathering wind power. On the other side of rotor, wind turns blades freely so that blades surfaces are parallel to wind direction. There is no need for mechanical means for turning of blades to implements of above operations. This way the wind generator has high efficiency and low manufacture cost.

### BACKGROUND OF THE INVENTION

Traditional blades of wind generator look like propellers. The force of wine acts on a blade is equal to two forces. One of the forces is rotating the rotor to generate electricity. The other is useless force bending the blade to the direction of wind, which requires to strengthen the blade.

### OBJECTS

The primary object of the present invention is to increase efficiency. Blade angles are changeable. The blades moving against wind are parallel to wind direction so that resistance to rotor rotation is minimized. The blade angles of blades gathering wind power are optimized to maximize efficiency. Usually, the area for gathering wind power is limited. The preset invention helps to maximize the size of the blades to cover more area. The blade covers from the top of the area all the way near the ground. And the shape of the blade is rectangular instead of circular. The other object is to reduce the manufacture cost of wind generator with simple structure. One more object is to gather weak wind power with huge blades.

### BRIEF DESCRIPTION OF THE FIGURES

FIG. 1 shows structure of the rotor. 1 is the rotor shaft. 2 is one of four rotor arms. 3 is one of four blade bearings around which blades turn. Every blade bearing is secured near the end of a rotor arm. 4 is one of four stoppers to limit turning of blade. The angle between the stopper and the rotor arm is 225 degree. 5 is one of springs on the stoppers to protect the blade when the blade hits the stopper. 6 is the rotor center line. 7 is Behind Side of the rotor arm. 8 is Ahead Side of the rotor arm. Ahead Side always moves ahead of the Behind Side while rotor is working. 8 and 7 are parallel to the rotor center line. Each stopper is secured at the end of a rotor arm, bending towards Ahead Side. 9 is one of four springs on rotor arms to protect blades when wind changes direction.

FIG. 2 shows structure of the wind blade. 1 is the blade. 2 is the blade shaft installed near one edge of the blade surface. 3 is one of two balance weights to make central weight of the blade at the shaft. The blade shaft is parallel to the rotor shaft so that the blade surface is always parallel to the rotor center line.

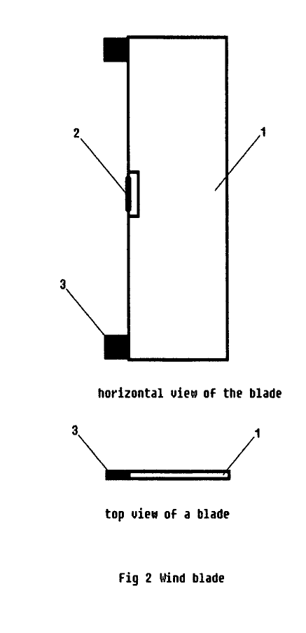

FIG. 3 shows blade positions while the wind generator is working. 1, 2, 3, and 4 are four positions of blade. Blades on the right side of the rotor stick with rotor arms to gather wind power. Blades on the left side of rotor can be turned freely by wind so that the blade surfaces are parallel to wind direction.

### DETAILED DESCRIPTION

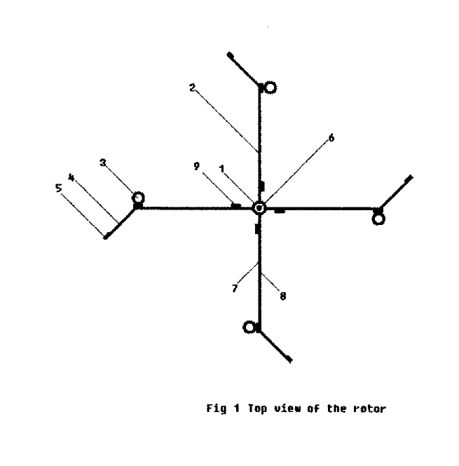

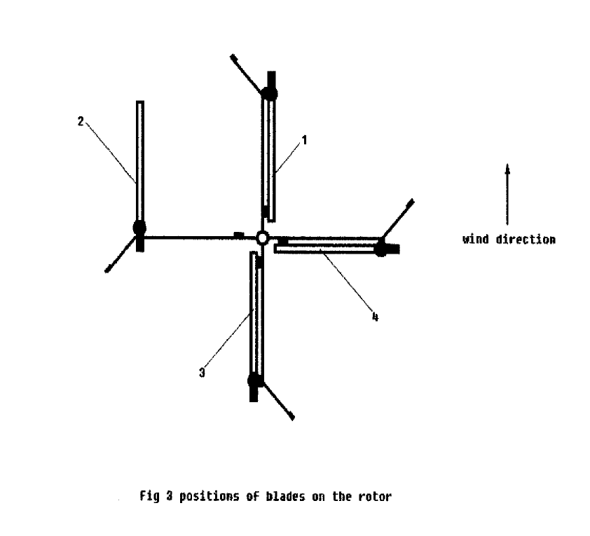

Let's call the side of rotor where blades gather wind power to rotate the rotor as Wind Power Zone. The right side of rotor in FIG. 3 is Wind Power Zone. Let's call the side of rotor where blades move against wind as Wind Against Zone. The left side of rotor in FIG. 3 is Wind Against Zone. The plane between Wind Power Zone and Wind Against Zone is parallel to wind direction. The rotor center line is in the plane. In this embodiment, the rotor is rotating horizontally and the rotor shaft is vertical. If the rotor shaft is horizontal, it works as well. In that case extra device may be needed to change the direction of rotor shaft when wind changes direction. It can be seen in FIG. 1 that each blade bearing is secured near the end of the rotor arm. The angle between a rotor arm and a blade can vary from zero degree to about 225 degrees. Let's call the angle as Blade Angle. It can be seen in FIG. 3, a blade in position 1 is just before entering Wind Against Zone. When a rotor arm passes from Wind Power Zone to Wind Against Zone, wind blows the blade to turn around the blade bearing. And Blade Angle changes from zero degree to 180 degree. When the blade makes this turning, the blade would not hit the stopper because the stopper is about 45 degree away in Wind Against Zone. Even if the blade hits the stopper, the spring on the stopper will depress strike. Wind makes the turning and absorbs extra kinetic energy of the turning blade that may cause striking. Wind turns blades on the Wind Against Zone freely. When a blade moves through the Wind Against Zone, the Blade Angle gradually reduces from 180 degree to zero degree. It can be seen in FIG. 3 Blade Angle of the blade at position 2 is 90 degrees. Blade surfaces in the Wind Against Zone are always parallel to the direction of wind. The resistance to rotor rotation is minimized. In FIG. 3, it can be seen Blade Angle of the blade at position 3 is zero degree. Blade Angle of the blade at position 4 is zero degree. When a rotor arm passes from Wind Against Zone to Wind Power Zone, the blade already sticks with the rotor arm. There is no strike between the blade and the rotor arm because the blade angle reduced gradually. There is no need for means of mechanical device to operate blades. All the Blade Angles on the Wind Power Zone are zero degree because all blades on Wind Power Zone keep sticking with rotor arms. Wind rotates the rotor through blades on the Wind Power Zone. In other words, wind blows rotor to rotate through the blades on Wind Power Zone. It can be seen in FIG. 1 that there are springs on the rotor arms to protect surface of blades when blades hit the rotor arm while wind changes direction.

Every blade has at least a balance weight to make the central weight of the blade at the blade shaft. The purposes are: 1) This makes the central weight of whole wind generator (the rotor and rotor arms plus the blades) at the rotor shaft. 2) Centrifugal force does not turn the blade while the rotor is rotating. Wind blow is the only cause to make blades in the Wind Against Zone to turn.

After wind changed direction, wind blow makes all blades in the Wind Against Zone parallel to the new wind direction. Wind blows blades in the Wind Power Zone to stick with a stopper or with a rotor arm on the Behind Side. The blade never sticks on Ahead Side of the rotor arm due to the stopper. The blade sticking with stopper in Wind Power Zone is able to gather wind power and rotate the rotor due to the proper angle between the stopper and the rotor arm. In this embodiment, the angle is 225 degrees. No matter the blades in the Wind Power Zone stick with rotor arm or with stopper, wind still rotates rotor through blades in the Wind Power Zone. After half rotation of the rotor, all blades get in normal positions as showed in FIG. 3.

What is claimed is:

1) A wind generator comprising a rotor and at last two blades held by blade bearings on rotor arms

2) a wind generator in claim 1, wherein said rotor arms have springs to protect blade surface when said blade turns to hit said rotor arm,

3) a wind generator in claim 1, wherein said rotor arm has a stopper to limit rotation of said blade so that Blade Angle between said blade and said rotor arm is always obviously less than 360 degrees,

4) a wind generator in claim 1, wherein each of said rotor arms is secured on said rotor with one end and has a blade bearing near or at other end to hold said blade so that wind turns said blade freely in Wind Against Zone to parallel to wind direction to minimize rotation resistance to said rotor and so that wind turns said blade in Wind Power Zone to stick with said rotor arm or to stick with said stopper to gather wind power for rotor rotation,

5) a wind generator in claim 3, wherein each of said stoppers is at a proper angle with said rotor arm so that said blade sticking with said stopper in Wind Power Zone are able to gather wind power for rotor rotation,

6) a wind generator in claim 3, wherein said stopper is bending from said rotor arm to Ahead Side of said rotor arm so that said blade would not hit said stopper when said blade is turned by wind while passing from Wind Power Zone to Wind Against Zone,

7) a wind generator in claim 3, wherein said stopper has a spring at the end to protect blade surface when wind blows said blade to hit said stopper,

8) a wind generator in claim 1, wherein surface of each of said blades is parallel to the center line of said rotor,

9) a wind generator in claim 1, wherein each of said blades has at least a blade shaft installed at one edge of the blade surface, all said blade shafts in each blade are in a blade shaft center line, said blade shafts are parallel to the center line of said rotor,

10) a wind generator in claim 9, wherein each of said blade shafts is held by one of said blade bearings so that wind can turn each said blade in Wind Power Zone to stick with said rotor arm or with said stopper to gather wind power for rotor rotation and so that wind can turn said blades in Wind Against Side to parallel to wind direction to minimize rotation resistance to said rotor,

11) a wind generator in claim 1, wherein each of said blade has at least a balance weight to make central weight of said blade at said blade shaft center line.
